(19) United States
(12) Patent Application Publication
(10) Pub. No.: US 2008/0258637 A1
(43) Pub. Date: Oct. 23, 2008

(54) LIGHT EMITTING ELEMENT DRIVER AND CONTROL METHOD THEREFOR

(76) Inventor: Shun Kei Leung, New Territories (HK)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/737,761

(22) Filed: Apr. 20, 2007

(51) Int. Cl. H05B 37/02; H05B 37/00

(52) U.S. Cl. 315/185 R; 315/224; 315/291

(57) ABSTRACT

A method of controlling a light emitting element to compensate for reduced brightness includes accumulating a power-on time of the light emitting element and adjusting a light emitting element driving signal in order to adjust the power supplied to the light emitting element dependent on the power-on time of the light emitting element.

### BACKGROUND OF THE INVENTION

The present invention relates to the field of light emitting element control and drivers, for example cold cathode fluorescent lamp or light emitting diode control.

Cold cathode fluorescent lamps (CCFL) are used in many applications, from illuminated signs to backlight units (BLU) for liquid crystal displays (LCD) used in computer and television screens for example. CCFL are susceptible to reduced brightness over their lifetime due to aging effects, principally consumption of Mercury ions (Hg+) and degradation of the fluorescent material within the lamp's tube. The useful lifetime of a CCFL is determined by how long it takes until the CCFL reaches half of its original luminance or brightness. Typical lifetimes for a CCFL are 30,000 hours, although some newer technology lamps have increased this time to 60,000 hours.

This dimming or reduced brightness effect of the CCFL as it ages is particularly problematic in BLU, where the LCD of a computer screen for example may become noticeably darker and more difficult for a user to read. Although it is possible for a user to manually recalibrate a CCFL by adjusting the power (voltage or current) applied to the CCFL in order to increase its brightness as measured by a nearby light meter, this procedure is often impractical in many CCFL applications.

Similarly, the brightness of light emitting diodes (LED) may vary due to aging. Accordingly, it would be advantageous to control the voltage and current to a CCFL in order to maintain adequate brightness levels.

### BRIEF DESCRIPTION OF THE DRAWINGS

For the purpose of illustrating the invention, there are shown in the drawings embodiments which are presently preferred. It should be understood, however, that the invention is not limited to the precise arrangements and instrumentalities shown. Elements in the figures are illustrated for simplicity and clarity and have not necessarily been drawn to scale. In the drawings:

FIG. 1 is a schematic diagram illustrating a driver architecture for a cold cathode fluorescent lamp (CCFL) according to an embodiment of the invention;

FIG. 2 is a graph that illustrates adjustment of a CCFL driving signal according to an embodiment of the invention;

FIG. 3 is a graph that illustrates adjustment of a CCFL driving signal according to another embodiment of the invention;

FIGS. 4A, 4B, and 4C are flow diagrams showing power up, power down, and timer methods respectively for implementation within the driver architecture of FIG. 1;

FIG. 5 is a flow chart illustrating a method of compensating for reduced brightness in a CCFL due to aging according to an embodiment of the invention;

FIG. 6 is a schematic block diagram illustrating a driver architecture for a light emitting diode (LED) and according to an embodiment of the invention;

FIG. 7 is a timing diagram that illustrates adjustment of a CCFL driving signal or dimming signal using pulse width modulation

FIG. 8 is a timing diagram that illustrates adjustment of a CCFL driving signal or dimming signal using pulse density modulation; and

FIG. 9 is a schematic diagram that illustrates an LED string architecture according to an embodiment of the present invention.

### DETAILED DESCRIPTION OF EMBODIMENTS OF THE INVENTION

In general terms, the present invention provides a device for and method of controlling a light emitting element in order to compensate for changes in brightness due to aging and/or temperature. Various types of light emitting elements may be controlled in this way, including for example fluorescent lamps, cold cathode fluorescent lamps (CCFL), incandescent light bulbs, and light emitting diodes (LED). A light emitting element driving signal, which drives the light emitting element, is adjusted automatically depending on the accumulated power-on time of the light emitting element.

In an embodiment of the invention, the power-on time of a CCFL light emitting element is accumulated using a timer by timing when the CCFL is illuminated or being driven. The accumulated time is stored in a non-volatile memory by a processor that generates an inverter driving signal for an inverter that drives or powers the CCFL. The driving signal for driving the CCFL is then automatically adjusted in order to adjust the power supplied to the CCFL dependent on the accumulated power-on time of the CCFL, which is stored in the non-volatile memory. An increase in supplied power increases the brightness of the CCFL to compensate for reduced brightness due to aging.

Adjusting the light emitting element (CCFL or LED) driving signal may additionally or alternatively be employed to compensate for increased or reduced brightness due to other light emitting element operating factors such as temperature. In an embodiment of the invention, a temperature sensor proximate the light emitting element provides a measure of the temperature of the light emitting element.

In another embodiment of the invention, an inverter driving signal such as a pulse width modulated signal (PWM) or other binary pulse train is received by an inverter and used to generate a sinusoidal or analog (CCFL) light emitting element driving signal for application to a CCFL. The duty cycle of the inverter driving signal is adjusted to increase or reduce the amplitude (voltage and/or current) of the (CCFL) light emitting element driving signal applied to the CCFL in order to increase or reduce the light output of the CCFL. This in turn increases or reduces the brightness of the CCFL. A suitable increase or reduction in the power supplied to the CCFL by the adjusted (CCFL) light emitting element driving signal compensates for a corresponding reduction or increase in the brightness of the CCFL due to aging and/or temperature changes.

In another embodiment of the invention, a dimming signal is used to switch an inverter (for CCFL) or a converter (for LED) on and off in order to switch the (CCFL or LED) light emitting element driving signal on and off. This in turn adjusts the brightness of the light emitting element (CCFL or LED). By reducing the duty cycle of the dimming signal, the average voltage and/or current of the (CCFL or LED) light emitting element driving signal is adjusted, and hence the power supplied and the corresponding brightness of the light emitting element (CCFL or LED) is also adjusted in order to compensate for changed brightness due to aging and/or temperature.

The duty cycle of the dimming signal and the inverter driving signal may be adjusted in various ways in the embodiments. For example pulse width modulation may be used where the width of the ON pulse of the (dimming or inverter driving) square wave is widened in order to increase the duty cycle. Alternatively the number of fixed width ON pulses per unit time (their frequency or density) may be adjusted.

Alternatively or additionally, the light emitting element driving signal may be adjusted by adjusting its voltage and/or current.

In another embodiment of the invention, the light emitting element driving signal is applied to a string of LEDs and may be adjusted in response to detecting a short circuit in one or more of the LEDs within the LED string. The LED string comprises a plurality of LEDs connected in series, and the current through the LED string and hence each LED should remain largely constant—the predetermined operating current for an LED or a string of series connected LEDs. A short circuit in one of the LEDs is detected by monitoring the voltage across a sub-set (e.g., one) of the LEDs of the LED string. A sudden change in the monitored voltage is indicative of a short circuit in one or more LEDs and the change in voltage is used to adjust the voltage applied to the whole LED string in order to maintain a constant current within the LED string.

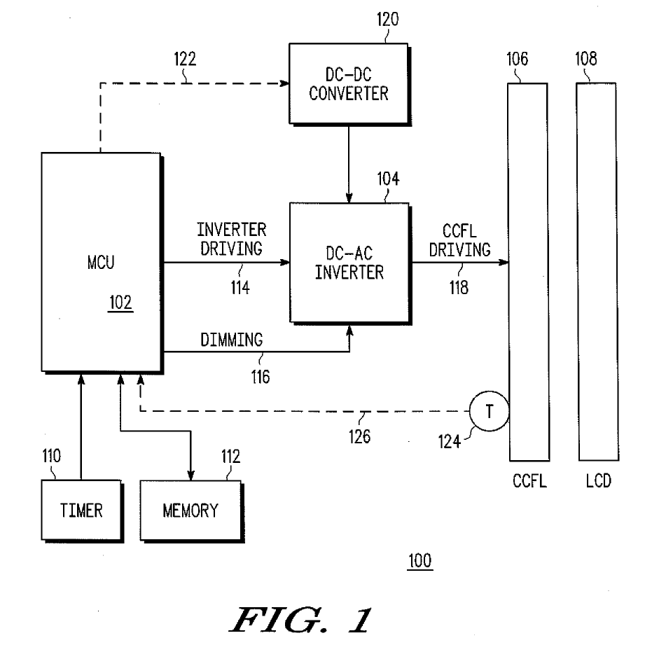

Referring now to the drawings, wherein like numbers refer to like elements, FIG. 1 shows a driver architecture 100 for controlling a light emitting element which in this embodiment is a CCFL. The driver architecture 100 comprises a microprocessor 102 coupled to a DC-AC inverter 104 which is coupled to a CCFL 106. In this embodiment, the CCFL 106 is located behind an LCD panel 108 in order to provide a BLU for back illuminating the LCD; for example in a laptop computer screen or large audio-visual flat panel screen. The microprocessor 102 is also coupled to a timer 110 and a non-volatile memory 112, for example a FLASH memory, and/or to other components that couple to non-volatile/battery backup memory such as battery backed SRAM.

The microprocessor 102 outputs an inverter driving signal 114 to an input of the DC-AC inverter 104, and may also output a dimming signal 116 to a control input of the inverter 104. The inverter driving signal 114 is typically a pulse train or binary square wave signal, usually at between 40-80 kHz. The inverter driving signal 114 is used to switch a larger DC voltage within the inverter 104, which in turn is input into an inductive load and smoothed in order to generate a sinusoidal or partially sinusoidal output as is known in order to provide a light emitting element driving signal 118 to the CCFL 106. Various commercially available DC-AC inverters 104 will be known to those skilled in the art.

Where used, the dimming signal 116 is a relatively low frequency digital signal, for example 100-600 Hz, which is used by the DC-AC inverter 104 to switch on/off the inverter driving signal 114 and hence the CCFL (or light emitting element) driving signal 118 to the CCFL 106. The duty cycle of the dimming signal 116 is normally set at 100% when the inverter driving signal 114 is always used to generate a corresponding (CCFL) light emitting element driving signal 118. However where reduced brightness of the CCFL 106 is required, the dimming signal 116 may be switched to a 50% duty cycle in which the inverter driving signal 114 is isolated from the inverter 104 half of the time, resulting in approximately half the light output from the CCFL 106. A predetermined level of dimming (e.g., duty cycle of 75%) may be used in a laptop computer screen when the computer is running on battery power and not mains power, in order to reduce battery consumption.

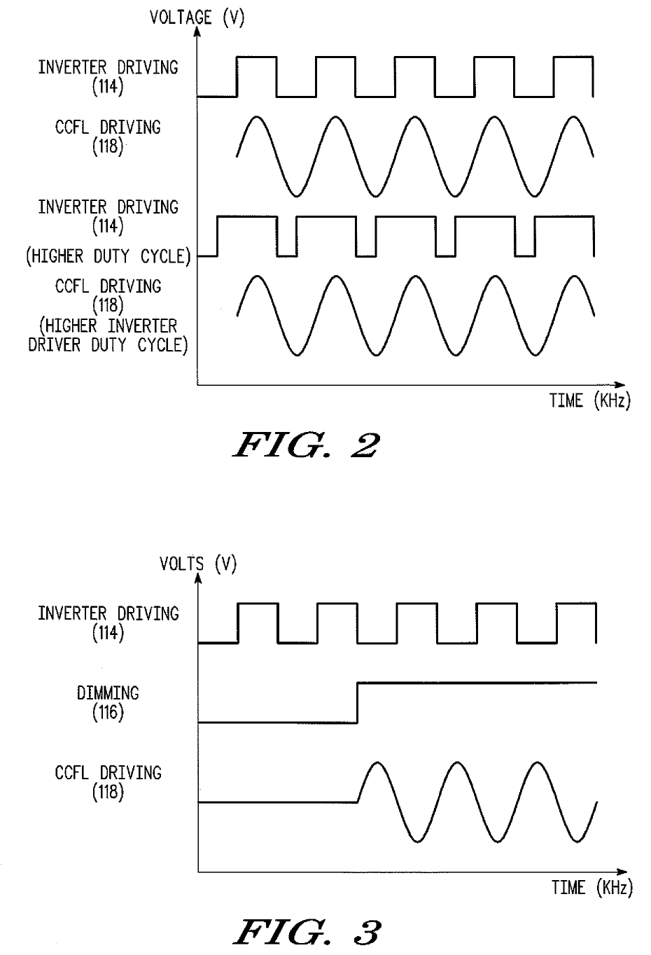

The microprocessor 102 can be used to generate the inverter driving signal 114, the dimming signal 116, or both. In one embodiment, the duty cycle of the inverter driving signal 114 is adjusted, in this case increased for example from 50% to 75% as shown in FIG. 2, in order to compensate for aging and hence reduced brightness in the CCFL 106. By increasing the duty cycle of the inverter driving signal 114, the peak and hence average amplitude of the voltage (and/or current) of the CCFL driving signal 118 is increased. This results in more power being supplied to or used by the CCFL 106 and a resulting increase in the brightness of the CCFL 106.

In another embodiment, the duty cycle of the dimming signal 116 is adjusted by increasing the on-time of the dimming signal 116 and hence increasing the on-time of the CCFL driving signal 118 as shown in FIG. 3. As will be appreciated, the inverter driving signal 114 and/or CCFL driving signal 118 is switched on and off within the DC-AC inverter 104 according to the dimming signal 116. For example the dimming signal 116 may have its duty cycle increased from 90% to 91% causing an increase in brightness of the CCFL 106, which can be used to compensate for reduced brightness in the CCFL 106 due to aging.

Depending on the configuration of the DC-AC inverter 104, the dimming signal 116 may be arranged to switch the inverter driving signal 114 off during the on period of the dimming signal cycle. In this case, the power applied to the CCFL 106 by the CCFL driving signal 118 is increased when the duty cycle of the dimming signal 116 is reduced.

The microprocessor 102 uses the timer 110 to determine the power-on time of the light emitting element or CCFL 106, in this embodiment by storing and updating or accumulating a power-on time parameter within the non-volatile memory 112. Although the timer 110 has been shown as separate from the microprocessor 102 for ease of explanation, it may in fact be implemented within the microprocessor 102 using suitable hardware and/or software as will be appreciated. Where the microprocessor 102 generates the inverter driving and dimming signals 114 and 116, the microprocessor 102 can easily monitor when these signals are output to the DC-AC inverter 104, and hence monitor the duration of each power-on session of the CCFL 106. The power-on time parameter of the light emitting element stored in the non-volatile memory 112 is retained even when the driver architecture 100 is powered off, and any new light emitting element (e.g., CCFL) power-on sessions or durations have their accumulated time added to the stored power-on time parameter in order to accumulate the total power-on time for the CCFL 106.

The memory 112 also stores a lookup table or algorithm that correlates the total power-on time of the CCFL with a compensation factor. The compensation factor indicates the increase in power needed to be applied to the CCFL 106 in order to compensate for reduced brightness due to the power-on time or ageing of the CCFL 106. Thus the compensation factor is used to maintain a substantially uniform brightness output from the CCFL 106 over the duration of its normal power-on lifetime. This compensation factor is then used to adjust the inverter driving signal 114 or dimming signal 116 in order to provide the extra power to the CCFL 106 in order to compensate for reduced brightness due to aging, that is an accumulated duration of power-on time.

For example where the total or accumulated power-on time is 12200 hours for a CCFL 106 with a lifetime of 30000 hours, the compensation factor may be 50%. In this case, the microprocessor 102 adjusts or sets the duty cycle of the inverter driving signal 114 to 75% where the duty cycle of the unused or new CCFL (with a power on time of zero) was 50%. In an alternative embodiment the duty cycle of the dimming signal 116 is adjusted from 50% when the CCFL 106 was unused to 75% in order to adjust for the reduction in brightness following 12200 hours of power-on time of the CCFL. The duty cycles may be adjusted up to 100% at the end of the normal commercial life of the CCFL 106 (e.g., 30000 hours).

Actual compensation factors for each or a number of power-on times may be derived experimentally, for example using a CCFL 106, a separate or external power-on duration meter or timer, and a light meter. The compensation factors may be input into the memory 112 as a lookup table, or provided as an algorithm or formula requiring the power-on time as an input.

In a further embodiment, the inverter driving signal 114 may be supplied to the DC-AC inverter 104 by a controller (not shown) separate from the microprocessor 102. In this case the microprocessor 102 may be arranged to control the dimming signal 116 to the inverter 104, which adjusts the CCFL light emitting element driving signal 118 in order to increase the power applied to the CCFL 106 in accordance with the accumulated power-on time of the CCFL 108. This power-on time may be determined by monitoring the inverter driving signal 114 or indeed the (CCFL) light emitting element driving signal 118 where the microprocessor 102 does not generate the inverter driving signal 114.

In a further alternative embodiment, the voltage and/or current of the CCFL light emitting element driving signal 118 is increased by controlling the power supply to the DC-AC inverter 104. In this case the inverter driving signal 114 and dimmer signal 116 (if used) remain constant. Again the power-on time of the CCFL 108 is determined using the timer 110, microprocessor 102 and non-volatile memory 112 arrangement described above, and a compensation factor obtained using a lookup table or suitable algorithm. The supply voltage provided to the DC-AC inverter 104 is then controlled to increase by an amount corresponding to the compensation factor. This may be implemented by a programmable DC-DC converter 120 supplying the inverter 104, and which is at least partially controlled by the microprocessor 102. A supply voltage control signal 122 is provided via a control connection between the microprocessor 102 and the DC-DC converter 120. Again the increase in voltage supplied to or switched by the DC-AC inverter 104 and required in order to compensate for reduced brightness due to aging in the CCFL may be determined experimentally.

Similarly an increase in current may be allowed to the CCFL 106 dependent on the determined power-on time of the CCFL 106 as will be appreciated by those skilled in the art. This may be implemented by reducing the reactance of the CCFL output circuit.

In a further embodiment, the (CCFL) light emitting element driving signal 118 is adjusted in response to changes in temperature of the CCFL 106. These changes in temperature can result in changes in brightness of the CCFL 106 as is known. A temperature sensor 124 located adjacent or otherwise associated with the CCFL 106 outputs a temperature signal 126 indicative of the temperature of the CCFL 106 to the microprocessor 102. The microprocessor 102 may be arranged to utilize a second lookup table in the non-volatile memory 112 in order to determine the adjustment in the CCFL driving signal 118 required in order to compensate for the change in temperature.

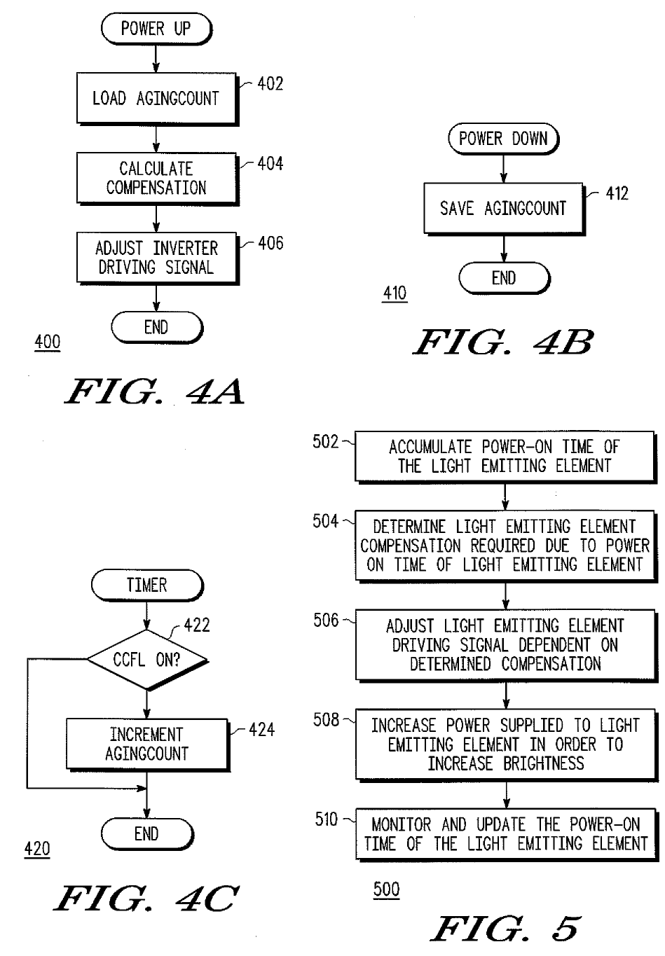

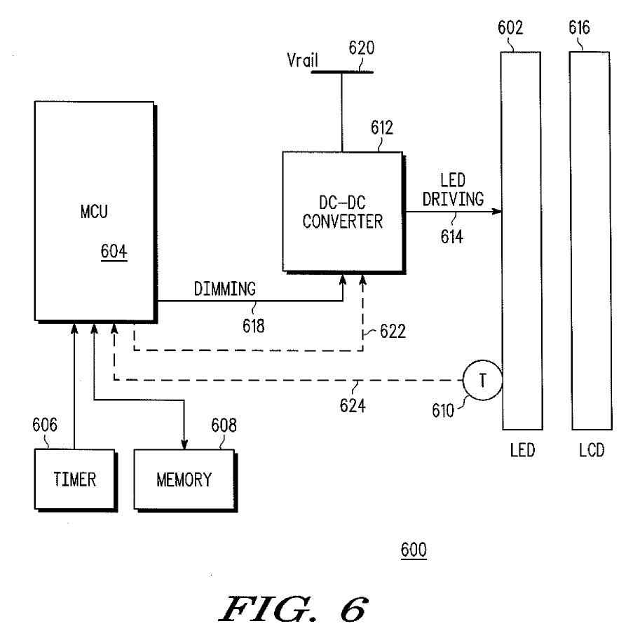

Referring now to FIGS. 4A, 4B, and 4C, three methods are illustrated in order to implement a total power-on time parameter corresponding to the power-on time of the CCFL 106 or other light emitting element These methods preferably are implemented by the microprocessor 102 of FIG. 1. The first method 400 illustrated in FIG. 4A is implemented at power-up of the driver 100. At step 402, the microprocessor 102 loads the power-on time parameter AgingCount from the non-volatile memory 112. The microprocessor 102 then calculates a compensation factor CompFact at step 404. As described above this may be implemented by referring to a lookup table also stored in the memory 112. At step 406, the microprocessor 102 adjusts the CCFL light emitting element driving signal 118, for example by increasing the duty cycle of a PWM based inverter driving signal 114. A starting or nominal duty cycle may be stored in the memory 112 and used for the CCFL 106 when new. From this nominal duty cycle a compensated duty cycle may be determined using the compensation factor, and used to generate the inverter driving signal 114. In embodiments where the dimming signal 116 is used to adjust the CCFL light emitting element driving signal 118 and hence the power output to the CCFL 106, the compensation factor is used to adjust the duty cycle of the dimming signal in order to increase the power applied to the (CCFL) light emitting element.

The second method 410 illustrated in FIG. 4B is implemented at power down of the driver 100. At step 412, the microprocessor 102 stores the current value of the power-on time parameter AgingCount back into the non-volatile memory 112. Because the memory is non-volatile, this parameter remains stored even when the driver 100 and/or CCFL 106 is powered off. In an alternative arrangement, the current AgingCount parameter may be stored or saved periodically back to the memory 112, irrespective of power down.

The third method 420 illustrated in FIG. 4C is implemented for each timer signal or input “tick” from the timer 110. The timer 110 is arranged to trigger a tick or timer signal every second, minute, hour, or any suitable time period. At step 422, when a timer signal or tick is received, the microprocessor 102 determines whether the CCFL 106 is powered on. That is, the microprocessor 102 determines whether the inverter driving signal 114 is active. If the CCFL 106 is not powered on, then the method 420 ends. If however the CCFL 106 is powered on, the microprocessor 102 increments the power-on time parameter AgingCount at step 424. The value of the increment depends on the timer tick duration and the data stored in the lookup table. The method 420 then ends and is performed again at the next timer signal or tick. Thus the power-on time parameter AgingCount is loaded from non-volatile memory 112, incremented or increased according to the power-on time of the CCFL, and the updated AgingCount or power-on time parameter is stored in the non-volatile memory 112. Thus the total or accumulated power-on time during which the CCFL 106 was powered on or there was a (CCFL) light emitting element or inverter driving signal being generated is stored as the power-on time of the CCFL 106.

FIG. 5 illustrates a method 500 according to an embodiment of the invention compensating for the reduced brightness in a light emitting element such as a CCFL due to aging. The method 500 at step 502 accumulates the power-on time of the light emitting element (e.g., CCFL) 106. This may be implemented using a timer and non-volatile memory as described above with respect to FIGS. 4A-C, however other methods of accumulating the power-on time of the light emitting element (CCFL) may be used. At step 504, the compensation amount required as a result of the light emitting element (CCFL) power on time is determined. As described above, the time amount may be determined using the accumulated power-on time and a lookup table. At step 506, the light emitting element (CCFL) driving signal 118 is adjusted depending on the determined compensation, and hence the accumulated power-on time of the light emitting element (CCFL) power-on time. As described above, this may be achieved by increasing the duty cycle of the inverter driving signal 114 for a CCFL embodiment, which increases the power supplied to the light emitting element, which increases the brightness or light output of the light emitting element as indicated at step 508. As the brightness of the light emitting element declines with age, the power applied to the light emitting element is increased to compensate and provide a substantially uniform brightness.

The light emitting element driving signal 118 may be adjusted (step 506) only at power up time as described above, or periodically where the CCFL is expected to be powered on for long periods. The power-on time is then accumulated again at step 502 at the next iteration of the method 500; for example at the next power up of the driver 100.

Although the embodiments have described the light emitting element as a CCFL, other light emitting elements could be used in alternative embodiments. For example other types of fluorescent lamps could be used that would require modified inverters as would be appreciated by those skilled in the art, but otherwise would be largely the same as described above with respect to FIGS. 1-5. In other embodiments incandescent light bulbs or light emitting devices (LED) could be used.

FIG. 6 illustrates an alternative embodiment driver architecture 600 used to drive a light emitting diode (LED) 602. The driver architecture 600 is similar to that of FIG. 1 and comprises a microcontroller unit 604 such as a microprocessor, a timer 606, a non-volatile memory 608 and a temperature sensor 610. Instead of the DC-AC inverter 104, a DC-DC converter 612 is employed, which generates a pulse train or digital (LED) light emitting element driving signal 614 which drives the LED 602. The LED or array of LEDs 602 may be located behind an LCD matrix 616 in order to provide backlighting.

A dimming signal 618 provided by the microprocessor 604 switches the DC-DC converter 612 or its output the driving signal 614 on and off according to a duty cycle set by the dimming signal 618. The DC-DC converter 612 receives power from a rail voltage (Vrail) 620, which is switched to provide the output light emitting element driving signal 614. The microprocessor 604 may also control the output voltage of the light emitting element driving signal 614 via a voltage control signal 622 which controls the programmable DC-DC converter 612. Alternatively the rail voltage 620 may be controlled by the microprocessor 604 in some other manner as will be appreciated by those skilled in the art.

As with previous embodiments, the power supplied to the light emitting element (LED) 602 is adjusted depending on the accumulated power-on time of the light emitting element. Reference is made to FIGS. 4A, 4B, and 4C for an example implementation.

The microprocessor 604 automatically adjusts the power supplied to the light emitting element 602 depending on the accumulated power-on time. This may be done in a number of ways. For example the voltage of the light emitting element driving signal 614 may be adjusted according to experimentally obtained data stored in a lookup table stored in the memory 608. This voltage may be adjusted using the voltage adjustment control signal 622 or another mechanism. Alternatively the duty cycle of the dimming signal 618 may be adjusted, for example by increasing or decreasing the on-time in a cycle compared with the off-time.

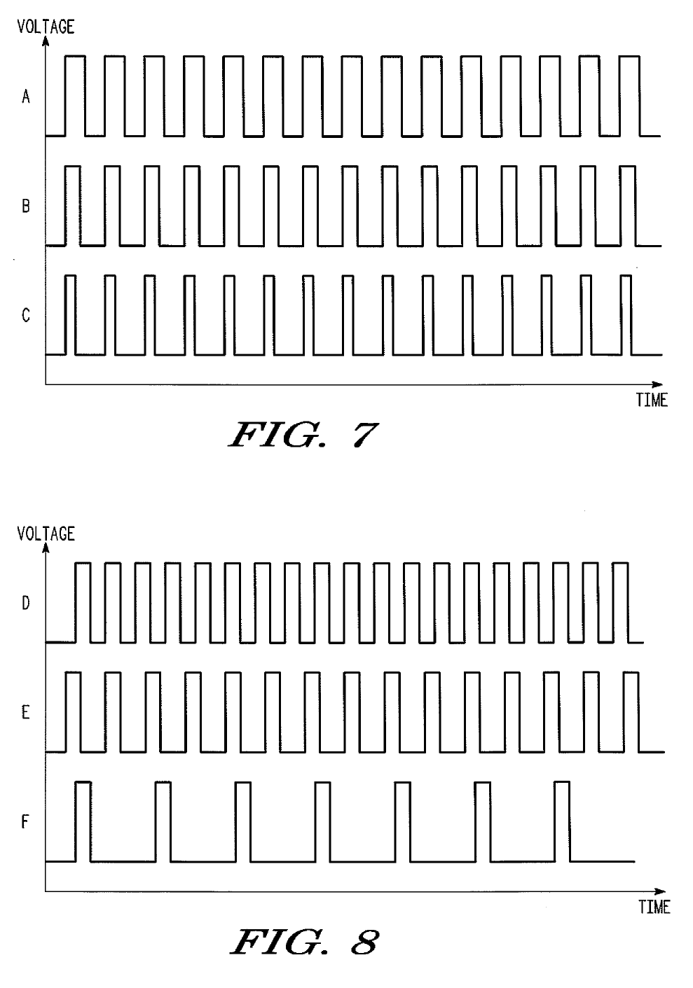

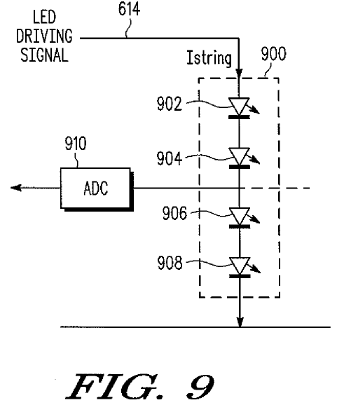

FIG. 7 and FIG. 8 show various waveforms of the duty cycle of the dimming signal 618. These waveforms could also represent the dimming signal 116 and the inverter driving signal 114 of CCFL embodiments. FIG. 7 illustrates pulse width modulation in which the width of the ON pulse or on-time of a pulse cycle is increased or reduced in order to increase or reduce the duty cycle. Waveforms A, B, C show decreasing duty cycle respectively. FIG. 8 illustrates pulse density modulation in which the width of the ON pulse or on-time of a pulse cycle is fixed but the number or density of the pulses increase or reduce in order to increase or reduce the duty cycle. This is also known as changing the pulse frequency. Waveforms D, E, F show decreasing duty cycle respectively.

FIG. 9 is a schematic diagram of an LED string 900 having a plurality of series connected LED 902, 904, 906, 908. The LED string 900 corresponds to the light emitting element 602 in FIG. 6 and is driven from the DC-DC converter 612 using the light emitting element driving signal 614. The DC-DC converter 612 is arranged to apply a voltage V_{string} to the LED string 900 in order to provide a constant predetermined operating current I_{string}. Typically, each LED 902-908 will have the same resistance so that there will be an equal voltage drop across each LED 902-908 as is known. If however one of the LED (e.g., 906) has a short circuit fault, the voltage drop across it will be zero or substantially less than the other LED (902, 904, 908). An analog-to-digital converter (ADC) 910 is connected to a mid-point of the LED string 900 as shown. The ADC 990 is also coupled to the microprocessor 604.

Normally the voltage Vₜₑₛₜ at this mid-point would be approximately half of the full voltage V_{string} applied to the LED string 900 by the DC-DC converter 612. By detecting a different mid-point voltage Vₜₑₛₜ, for example a predetermined voltage (e.g., V_{string}/3) corresponding to a short circuited LED 906, the microprocessor 604 can be arranged to adjust the voltage V_{string} applied by the DC-DC converter 612, for example to 0.75 V_{string} in order to maintain the predetermined operating current I_{string} through the remaining functional LEDS 902, 904, 908. This enables a substantially constant brightness of the LED string 900 to be maintained in the event of a short circuit to one of the LEDS 915 within the LED string 900.

Although the embodiments have been described with respect to a backlighting unit (BLU) for an LCD screen, the embodiments could also be used in alternative lighting apparatus, for example a lighting panel used to highlight medical scans or simply as room lighting.

The skilled person will recognize that the above-described apparatus and methods may be embodied as processor control code, for example on a carrier medium such as a disk, CD- or DVD-ROM, programmed memory such as read only memory (firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

The skilled person will also appreciate that the various embodiments and specific features described with respect to them could be freely combined with the other embodiments or their specifically described features in general accordance with the above teaching. The skilled person will also recognize that various alterations and modifications can be made to specific examples described without departing from the scope of the appended claims

1. A method of controlling a light emitting element to compensate for reduced brightness, the method comprising:
accumulating a power-on time of the light emitting element;
automatically adjusting a light emitting element driving signal in order to adjust the power supplied to the light emitting element dependent on the accumulated power-on time of the light emitting element.

2. The method of controlling a light emitting element according to claim 1, wherein the light emitting element is a fluorescent lamp and adjusting the light emitting element driving signal comprises adjusting a duty cycle of an inverter driving signal used to generate the light emitting element driving signal.

3. The method of controlling a light emitting element according to claim 2, further comprising generating the inverter driving signal, and wherein accumulating the power on time of the light emitting element comprises accumulating the power-on times of the durations when the inverter driving signal is being generated.

4. The method of controlling a light emitting element according to claim 1, wherein adjusting the light emitting element driving signal comprises adjusting a duty cycle of a dimming signal used to switch the light emitting element driving signal on and off.

5. The method of controlling a light emitting element according to claim 1, wherein the light emitting element is a light emitting diode and adjusting the light emitting element driving signal comprises adjusting the voltage of the light emitting element driving signal.

6. The method of controlling a light emitting element according to claim 1, further comprising measuring a temperature of the light emitting element and automatically adjusting the light emitting element driving signal dependent on the temperature of the light emitting element.

7. A light emitting element driver, comprising:
a processor arranged to accumulate a power on-time of a light emitting element and generate a light emitting element driving signal that supplies power to the light emitting element; and
a non-volatile memory coupled to the processor for receiving and storing the accumulated power-on time, wherein the processor is arranged to automatically adjust the light emitting element driving signal in order to adjust the power supplied to the light emitting element dependent on the accumulated power-on time of the light emitting element.

8. The light emitting element driver of claim 7, further comprising:
an inverter coupled to the processor for generating the light emitting element driving signal for driving a fluorescent lamp based on an inverter driving signal generated by the processor, wherein the processor adjusts a duty cycle of the inverter driving signal in order to adjust the power supplied to the light emitting element.

9. The light emitting element driver of claim 7, further comprising:
wherein the processor generates an inverter driving signal and a dimming signal, and
an inverter coupled to the processor and receiving the inverter driving signal and generating the light emitting element driving signal for driving a fluorescent lamp, wherein the inverter switches the light emitting element driving signal on and off in accordance with the dimming signal, and wherein the processor adjusts a duty cycle of the dimming signal in order to adjust the power supplied to the light emitting element.

10. The light emitting element driver of claim 7, further comprising:
a converter, coupled to the processor, for generating the light emitting element driving signal for driving a light emitting diode, wherein the converter switches the light emitting element driving signal on and off according to a dimming signal, wherein the processor adjusts a duty cycle of the dimming signal in order to adjust the power supplied to the light emitting element.

11. The light emitting element driver of claim 7, further comprising:
a timer coupled to the processor for accumulating the power-on time of the light emitting element when the light emitting element driving signal is driving the light emitting element.

12. The light emitting element driver of claim 7, further comprising:
a temperature sensor proximate to the light emitting element and coupled to the processor, wherein the processor receives a temperature signal from the temperature sensor and adjusts the light emitting element driving signal in accordance with the temperature signal.

13. A method of controlling a plurality of series connected light emitting diodes having a predetermined operating current, the method comprising:
detecting a short circuit across one of the light emitting diodes; and
automatically reducing a voltage applied across the plurality of series connected light emitting diodes in response to the detected short circuit.

14. The method of controlling a plurality of series connected light emitting diodes according to claim 13, wherein detecting the short circuit across one of the light emitting diodes comprises detecting a voltage change across a sub-set of the plurality of series connected light emitting diodes.

15. The method of controlling a plurality of series connected light emitting diodes according to claim 13, wherein the voltage applied is reduced in order to maintain the predetermined operating current through the plurality of series connected light emitting diodes.
